(19) United States
(12) Patent Application Publication
(10) Pub. No.: US 2026/0235148 A1
(43) Pub. Date: Aug. 13, 2026

(54) FASTENING ELEMENT FOR PANELS OF A PIECE OF FURNITURE AND PANEL FOR SUCH A FASTENING ELEMENT

(71) Applicant: COSTRUZIONE ACCESSORI ROVOLETTO S.R.L., FOSSO' (VE) (IT)

(72) Inventor: Stefano ROVOLETTO, Fosso' (IT)

(21) Appl. No.: 19/471,801

(22) PCT Filed: Mar. 27, 2024
(86) PCT No.: PCT/IB2024/052977

§ 371 Date: Oct. 2, 2025

(30) Foreign Application Priority Data
Apr. 3, 2023 (IT) 102023000006459

(51) Int. Cl. F16B 12/22; F16B 12/14

(52) U.S. Cl. CPC F16B 12/22; F16B 12/14

(57) ABSTRACT

The present invention relates to a fastening element (10, 110) for panels (11, 12) of a piece of furniture (13), said element (10, 110) extending longitudinally and comprising: —a head (15, 115), at a first longitudinal end (21, 12 1) thereof, —a stem (14,114) extending from said head (15, 115) and ending with a tip (30, 130). Said head (15, 115) has a plurality of substantially discoidal peripheral portions (l6, 17, 18, 116, 117, 118). The invention further relates to a panel (1 l) of a piece of furniture (13) for said fastening element (10, 110).

### BACKGROUND OF THE INVENTION

The present invention relates to a fastening element for furniture panels.

The invention further relates to a furniture panel for a similar fastening element.

Nowadays, fastening elements such as dowels, pins, screws, etc. are widely used to mutually fasten the panels of a piece of furniture.

Dowel elements usually have:
a stem, adapted to be inserted in a corresponding hole obtained on a first panel,
an enlarged head, at a longitudinal end of the stem, adapted to be inserted in a corresponding hole/slot obtained on a second panel, and/or adapted to engage with an element associated with the second panel such as, for example, a bush, a screw or a pin.

To assemble a piece of furniture, the stem of the fastening element is inserted in a hole of a first panel, into which glue has previously been inserted.

Then the head of the fastening element is inserted in a hole/slot of a second panel.

If the second panel has a hole, the head is normally inserted, after applying glue, or a respective coupling bush.

If the second panel has a slot, this generally comprises:
a first portion with an enlarged section for the entire depth of the slot, which first portion is substantially circular and/or counter-shaped to the head of the fastening element,
a second portion with longitudinal extension, in turn having:
an enlarged section in the innermost and deepest stretch, which enlarged section has a width comparable to the diameter of the head of the fastening element,
a narrowed section in the outermost and most surface stretch, which narrowed section has a width smaller than the diameter of the head of the fastening element.

The fastening element is then bayonet-anchored to the second panel, inserting the head in the first portion and sliding it along the second portion. Also in this case, the head is usually inserted in the slot after applying glue.

Such known techniques have some drawbacks.

In fact, in order to ensure the fastening and seal over time, under the action of loads which can even be in the order of 50 N, it is necessary to use glue and/or a bush which are inserted in the hole/slot before the introduction of the head.

This determines the need for a considerable amount of glue and/or bushes, which must be inserted into every single hole/slot in the panels, resulting in a long and uncomfortable manufacturing process for the furniture.

Furthermore, the use of glue and/or bushes, in addition to the fastening elements between the panels, determines a considerable cost and waste of material.

Further, the use of glues causes the dispersion of substances which are toxic for operators and pollutants for the environment.

### BRIEF SUMMARY

The task of the present invention is to make a fastening element for furniture panels and a furniture panel for a similar fastening element which are capable of improving the prior art in one or more of the aspects indicated above.

Within the scope of such a task, an object of the invention is to make a fastening element for furniture panels and a furniture panel for a similar fastening element which allow the use of glues to be reduced/eliminated, simultaneously ensuring the seal over time under the action of considerable loads.

Another object of the invention is to develop a fastening element for furniture panels and a furniture panel for a similar fastening element which allow a simpler and easier manufacturing process for the furniture with respect to similar known methods, and without the use of toxic and polluting substances.

Furthermore, the present invention has the object of overcoming the drawbacks of the prior art in an alternative manner to any existing solutions.

A not least object of the invention is to make a fastening element for furniture panels and a furniture panel for a similar fastening element which are highly reliable, relatively easy to manufacture and at competitive costs.

This task, as well as these and other objects which will become clearer below, are achieved by a fastening element for furniture panels, according to claim 1.

More in detail, according to the invention, said fastening element extends longitudinally and comprises:
a head, at a first longitudinal end thereof,
a stem extending from said head and ending with a tip,
said fastening element being characterized in that said head has a plurality of substantially discoidal, peripheral portions.

As will be better explained below, some of said discoidal portions are adapted to couple in a forced manner with corresponding stretches of a slot obtained in a corresponding panel to be joined to that on which the fastening element is mounted.

This task, as well as these and other objects which will become clearer below, are achieved by a furniture panel for a similar fastening element, according to claim 14 and by a piece of furniture comprising said fastening element and said panel, according to claim 15.

### BRIEF DESCRIPTION OF THE DRAWINGS

Further features and advantages of the invention will become clearer from the description of some preferred, but not exclusive, embodiments of the fastening element for furniture panels and of the furniture panel for a similar fastening element, according to the invention, illustrated by way of indicative and non-limiting purposes in the attached drawings, in which:

FIG. 1 illustrates a perspective view of a fastening element for furniture panels, according to the invention, in a first embodiment;

FIG. 2 illustrates a different perspective view of the fastening element of FIG. 1;

FIG. 3 illustrates an orthogonal view of the fastening element of FIG. 1;

FIG. 4 illustrates a perspective view of a fastening element for furniture panels, according to the invention, in a second embodiment;

FIG. 5 illustrates an orthogonal view of the fastening element of FIG. 4;

FIG. 6 illustrates a sectional view of a fastening element for furniture panels, according to the invention, in an application of use;

FIG. 7 illustrates a perspective view of a furniture panel, according to the invention;

FIG. 8 illustrates an enlarged detail of the panel of FIG. 7;

FIG. 9 illustrates a sectional view of a portion of the panel of FIG. 7.

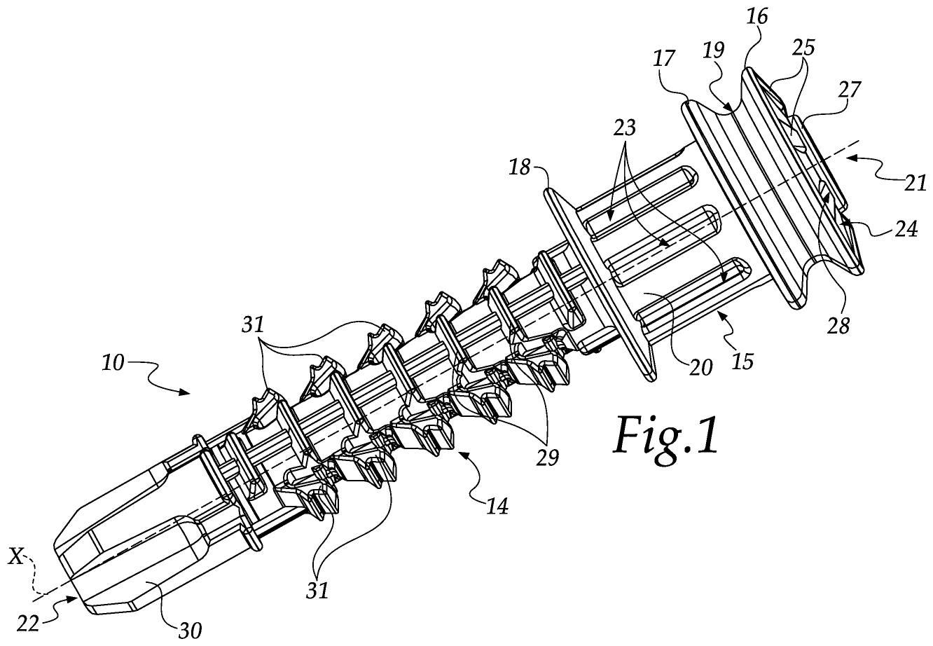

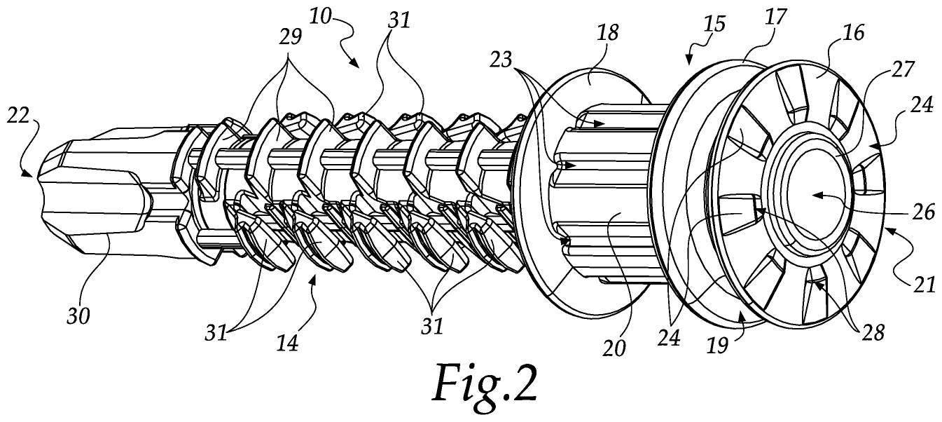

### DETAILED DESCRIPTION

With reference to the cited figures, a fastening element for furniture panels, according to the invention, in a first embodiment, is indicated globally with the reference number 10. The fastening element 10 is used to mutually fasten two panels 11, 12 of a piece of furniture 13.

The element 10 extends longitudinally and is made of plastic material, such as nylon.

According to the invention, the element 10 comprises:
a head 15, at a first longitudinal end 21 thereof,
a stem 14 extending from the head 15.

The stem 14 ends with a tip 30 arranged at a second longitudinal end 22 of the element 10, opposite the first end 21.

One of the peculiarities of the fastening element 10 consists in the fact that the head 15 has a plurality of substantially discoidal peripheral portions 16, 17, 18.

Such substantially discoidal portions 16, 17, 18 are arranged on lying planes orthogonal to the longitudinal extension axis X of the element 10.

Advantageously, the head 15 has:
a first substantially discoidal portion 16, at a first end thereof, corresponding to the first end 21 of the element 10,
a second substantially discoidal portion 17, close to the first substantially discoidal portion 16,
a third substantially discoidal portion 18, at a second end thereof corresponding to the interface area with the stem 14.

The third substantially discoidal portion 18 is, in fact, a limit switch element for the stem 14 during the insertion of the latter in the corresponding hole F of the respective panel 12.

The third discoidal portion 18 prevents the stem 14 from entering the corresponding hole F more than necessary, ensuring the head 15 is completely outside the hole F.

Thereby, the head 15 can be inserted adequately and correctly into the corresponding slot A of the respective panel 11.

In particular, said third substantially discoidal portion 18 ensures a correct coupling of the latter with the slot A, for example avoiding excessive efforts during assembly and/or an excessive permanent deformation of the slot itself.

The first substantially discoidal portion 16 and the second substantially discoidal portion 17, as will be better explained below, thanks to an interference coupling, are adapted to lock the head 15 in the slot A of the panel.

In particular, a first peripheral groove 19 is interposed between the second substantially discoidal portion 17 and the first substantially discoidal portion 16, extending along the entire transverse perimeter of the head 15.

In the present description, the term “transverse” refers to what is on a transverse plane, i.e., orthogonal to the longitudinal extension axis X of the fastening element.

The first groove 19 allows the first substantially discoidal portion 16 to elastically deform towards the second substantially discoidal portion 17, when inserting the head 15 in the respective slot A of the corresponding panel 11, as better explained below.

Such a deformation increases the pressure between the surfaces of the substantially discoidal portions 16, 17 and the surfaces of the slot A of the panel 11, increasing the locking force.

In particular, the adoption of the two substantially discoidal portions 16, 17 of the head 15, which cooperate with the slot A of the respective panel 11, allows both the resistance of the connection to be increased with respect to an axial force, in the longitudinal extension direction of the fastening element, and to increase the contact surface between the head 15 and the slot A, generating a greater friction, and therefore locking, force.

Advantageously, the substantially discoidal portions 16, 17, 18 have an external diameter of substantially the same size.

The head 15 has a portion 20 with a substantially cylindrical profile, interposed between the second substantially discoidal portion 17 and the third substantially discoidal portion 18.

The substantially discoidal portions 16, 17, 18, and the portion 20 with a substantially cylindrical profile, are coaxial and their axis coincides with the longitudinal extension axis X of the element 10.

In particular, such a portion 20 with a substantially cylindrical profile has a plurality of second longitudinal grooves 23, each with an extension axis parallel to the longitudinal extension axis X of the element 10.

Such second grooves 23 are adapted:
to increase friction with the corresponding portion of the edge of the slot A of the panel 11 into which the head 15 is adapted to be inserted, as described below, improving the anchoring therebetween,
to lighten the head 15, saving material during moulding.

The first substantially discoidal portion 16 has on its external discoidal surface 24 a plurality of first radially extending reliefs 25.

The head 15 has a hollow body with a blind hole 26, which has an extension axis coinciding with the longitudinal extension axis X of the element 10.

The hole 26 allows the element 10 to be lightened, saving material during the moulding of the latter.

Such a hole 26 has an inlet edge 27, protruding from the external discoidal surface 24 of the first substantially discoidal element 16.

In particular, the inlet edge 27 of the hole 26 has a protrusion from the external discoidal surface 24 which is greater than that of the first reliefs 25.

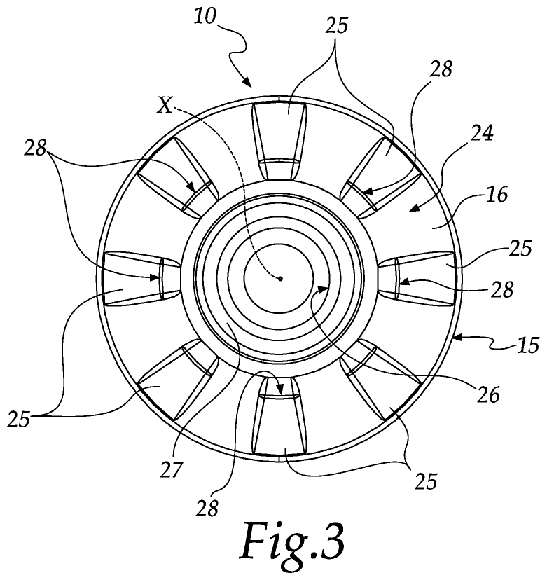

With particular reference to FIG. 3, the first reliefs 25 extend substantially from the inlet edge 27 of the hole 26 to the external perimeter of the external discoidal surface 24 of the first substantially discoidal element 16.

Such first reliefs 25 each have an area 28 of maximum protrusion, from the external discoidal surface 24, near the inlet edge 27.

The first reliefs 25 are adapted to increase friction with the corresponding portion of the edge of the slot A of the panel 11 in which the head 15 is adapted to be inserted, improving the anchoring therebetween and hindering the rotation of the head 15 inside the slot A.

In a similar manner, as will be better described below, the inlet edge 27 of the hole 26 is also adapted to cooperate with a corresponding stretch of the slot A. In detail, said inlet edge 27 generates an axial thrust in the longitudinal extension direction of the fastening element 10. Said thrust contributes to elastically deforming the first and second substantially discoidal portions (16, 17), increasing friction with the surfaces of the slot A.

The stem 14 of the element 10 has a plurality of teeth 29, 31.

Advantageously, the stem 14 has:
a plurality of first rigid teeth 29,
a plurality of second flexible teeth 31.

The expression “rigid teeth” in the present description means that such teeth have no possibility of moving with respect to the longitudinal extension axis X of the fastening element 10.

The expression “flexible teeth” in the present description means that such teeth can deform elastically and move with respect to the longitudinal extension axis X of the fastening element 10, if subjected to a stress.

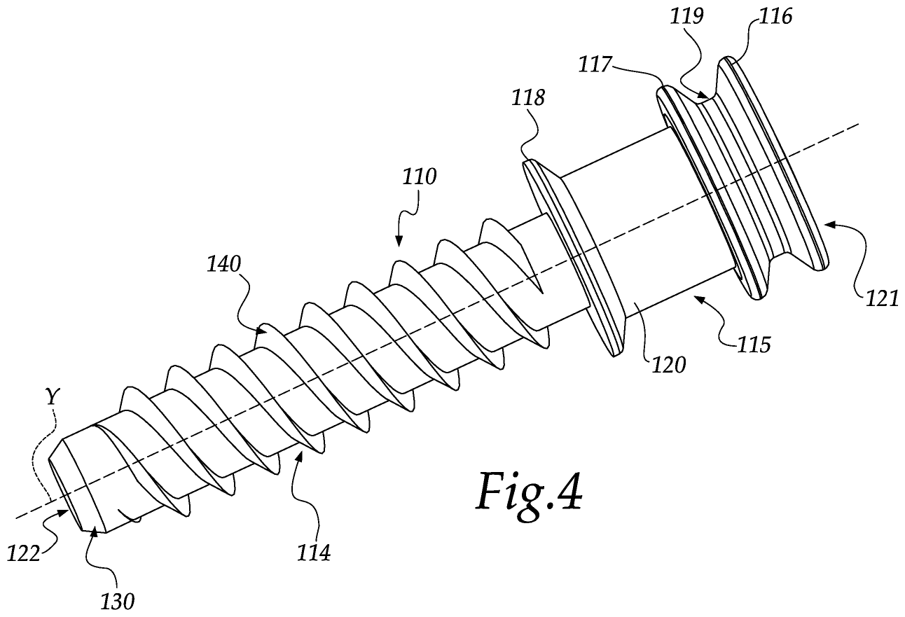

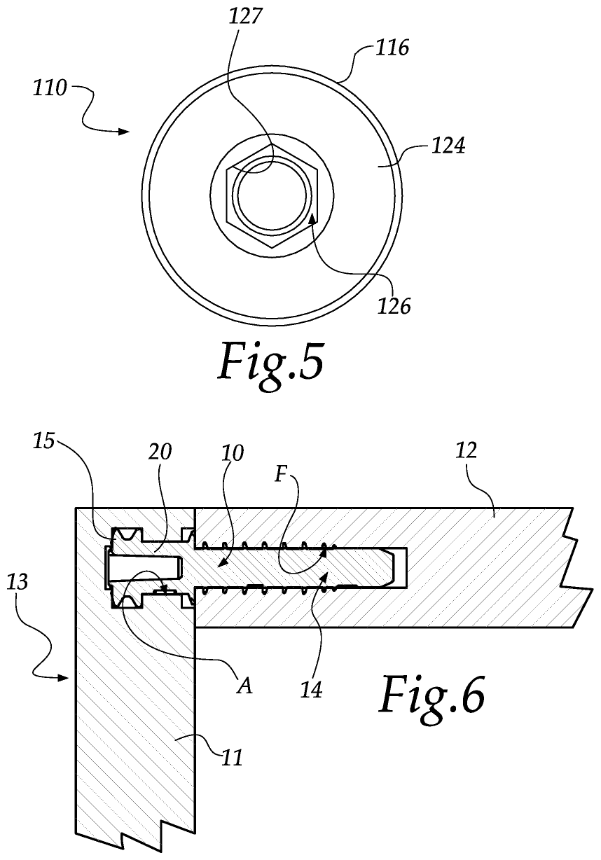

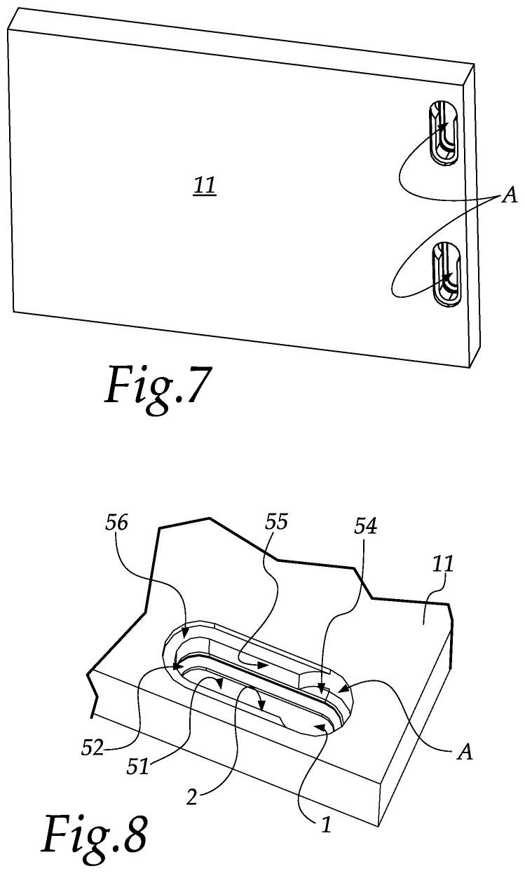

FIGS. 4 and 5 illustrate a fastening element for furniture panels, according to the invention, in a second embodiment, indicated globally with the reference number 110.

Similarly to the first embodiment, the element 110 comprises:
a head 115, at a first longitudinal end 121 thereof,
a stem 114 extending from the head 115.

The stem 114 ends with a tip 130 arranged at a second longitudinal end 122 of the element 110, opposite the first end 121.

The head 115 has a plurality of substantially discoidal portions 116, 117, 118. Such substantially discoidal portions 116, 117, 118 are arranged on lying planes orthogonal to the longitudinal extension axis Y of the element 110.

As in the first embodiment, illustrated above, the head 115 has:
a first substantially discoidal portion 116, at a first end thereof, corresponding to the first end 121 of the element 110, a second substantially discoidal portion 117, close to the first substantially discoidal portion 116, a third substantially discoidal portion 118, at a second end thereof corresponding to the interface area with the stem 114.

A first peripheral groove 119 is interposed between the second substantially discoidal portion 117 and the first substantially discoidal portion 116, extending along the entire transverse perimeter of the head 115.

Advantageously, the substantially discoidal portions 116, 117, 118 have an external diameter of substantially the same size.

The head 115 has a portion 120 with a substantially cylindrical profile, interposed between the second substantially discoidal portion 117 and the third substantially discoidal portion 118.

The substantially discoidal portions 116, 117, 118, and the portion 120 with a substantially cylindrical profile, are coaxial and their axis coincides with the longitudinal extension axis Y of the element 110.

Similarly to the first embodiment of the fastening element, also in the second embodiment thereof, the portion 120 with a substantially cylindrical profile can have a plurality of second longitudinal grooves, not illustrated in the figures, each with an extension axis parallel to the longitudinal extension axis Y of the element 110.

Furthermore, the first substantially discoidal portion 116 can have on the external discoidal surface 124 thereof, a plurality of first reliefs extending radially, not illustrated in the figures, and similar to those described previously with reference to the first embodiment of the fastening element, according to the invention.

The head 115 has a hollow body with a blind hole 126, which has an extension axis coinciding with the longitudinal extension axis Y of the element 110.

The hole 126 has an inlet edge 127 with a shaped profile for the shape coupling with a tool adapted to allow the screwing of the stem 114 to its corresponding hole on the respective panel.

For example, the hole 126 has an inlet edge 127 with a hexagonal profile for the shape coupling with a hex wrench.

Advantageously, the stem 114 has a thread 140, adapted to allow the screwing in a corresponding hole in the respective panel and possibly to self-thread the latter.

The invention further relates to a panel 11 of a piece of furniture for a fastening element 10, 110, according to the invention.

Such a panel 11 has one or more slots A suitable for the insertion of the head 15, 115, of a corresponding fastening element 10, 110.

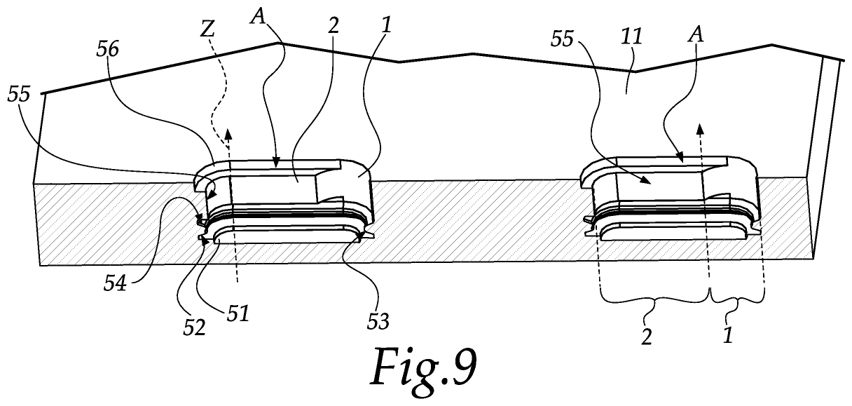

With particular reference to FIG. 9, the slot A comprises, considering a direction Z, orthogonal to the lying plane of the panel 11 and from the inside towards the outside of the slot A, in order:
a first stretch 51, with a substantially oval profile and a width comparable to the external diameter of the inlet edge 27 of the hole 26, 126, of the head 15, 115,
a second stretch 52, with a substantially oval profile, with a length and width greater than the length and width of the first stretch 51, and with a width comparable to the external diameter of the first substantially discoidal portion 16, 116, of the fastening element 10, 110,
a third stretch 53, with a substantially oval profile, with a length and width smaller than the length and width of the second stretch 52, and with a width comparable to the external diameter of the first groove 19, 119, of the head 15, 115,
a fourth stretch 54, with a substantially oval profile, with dimensions substantially comparable to the dimensions of the second stretch 52, and with a width comparable to the external diameter of the second substantially discoidal portion 17, 117, of the fastening element 10, 110,
a fifth stretch 55 with a height greater than the height of the first stretch 51, the second stretch 52, the third stretch 53 and the fourth stretch 54, which fifth stretch 55 in turn has:
   an enlarged portion 1, with an at least partially circular profile with a diameter comparable to the width of the second stretch 52 and to the external diameter of the head 15, 115 of the fastening element 10, 110,
   a narrowed portion 2, at least partially with a substantially oval profile, with a width smaller than the width of the fourth stretch 54, and comparable to the external diameter of the substantially cylindrical portion 20, 120, of the head 15, 115, of the fastening element 10, 110,
a sixth stretch 56, with a substantially oval profile, and dimensions comparable to the dimensions of the second stretch 52 and/or the fourth stretch 54, and a width comparable to the external diameter of the third substantially discoidal portion 18, 118, of the head 15, 115, of the fastening element 10, 110.

In the present description:
the term “width” means the dimension defined by the distance between corresponding points of the straight stretches of the substantially oval profile,
the term “length” means the dimension defined by the maximum distance between corresponding points of the curvilinear stretches of the substantially oval profile,
the term “height” means the dimension in the direction orthogonal to the lying plane of the substantially oval profile.

The use of the fastening element 10, 110, and the panel 11, according to the invention, during the assembly of a piece of furniture is as follows.

The stem 14, 114, of the fastening element 10, 110, is inserted in a respective hole F of the corresponding panel 12.

In the case of the first embodiment of the fastening element, the stem 14 is inserted in the hole F by pressure, for example by using a hammer.

In the case of the second embodiment of the fastening element, the stem 114 is inserted in the hole by screwing, acting with a tool in the hole 126 of the head 115.

The stem 14, 114 is inserted in the hole F of the corresponding panel 12, for its entire extension, up to the third substantially discoidal portion 18, 118 of the head 15, 115.

At this point the head 15, 115 is inserted in the respective slot A of the corresponding panel 11.

In particular, the head 15, 115, is introduced inside the slot A through the enlarged portion 1 of the fifth stretch 55 and is pushed inside the slot A along its entire extension.

As a result of the pressure exerted during insertion, the first substantially discoidal portion 16, 116 deforms elastically at the third stretch 53, snap-fitting into the second stretch 52. At this point the head 15, 115, of the fastening element 10, 110, is translated into the narrowed portion 2 of the fifth stretch 55 of the slot A up to the end of such a stretch opposite that with the enlarged portion 1, creating a bayonet coupling between the fastening element 10, 110, and the panel 11.

Due to the effect:
of the shape coupling between the first stretch 51, which is at least partially counter-shaped to the inlet edge 27 of the hole 26, 126, and the inlet edge 27 of the hole 26, 126,
of the shape coupling between the second stretch 52, which is at least partially counter-shaped to the first substantially discoidal portion 16, 116, and the latter,
of the shape coupling between the third stretch 53, which is at least partially counter-shaped to the first groove 19, 119, and the latter,
of the shape coupling between the fourth stretch 54, which is at least partially counter-shaped to the second substantially discoidal portion 17, 117, and the latter,
of the shape coupling between the fifth stretch 55, which is at least partially counter-shaped to the substantially cylindrical portion 20, 120, and the latter,
of the shape coupling between the sixth stretch 56 which is at least partially counter-shaped to the third substantially discoidal portion 18, 118, and the latter,
of the friction determined by the interaction between the first reliefs 25 and the corresponding surface of the slot A,
of the friction determined by the interaction between the second grooves 23 and the corresponding edge of the fifth stretch 55,
an anchoring is created between the panel 11 and the fastening element 10, 110, and therefore between the panel 11 and the other panel 12, capable of resisting considerable loads, even in the order of 70 N, as demonstrated by tests carried out.

It should be noted that, with a fastening element and a panel, according to the invention, it is possible to assemble a piece of furniture without using glues and/or other elements.

In practice, it has been found how the invention achieves the intended task and objects by making a fastening element for furniture panels and a furniture panel for a similar fastening element which allow the use of glues to be reduced/eliminated, simultaneously ensuring the seal over time under the action of considerable loads.

With the invention, a fastening element has been developed for furniture panels and a furniture panel for a similar fastening element which allow a simpler and easier manufacturing process for the furniture with respect to similar known methods and without the use of toxic and polluting substances.

The invention, as conceived, is susceptible to numerous modifications and variations, all of which fall within the scope of the inventive concept; furthermore, all the details may be replaced by technically equivalent elements.

In practice, the materials used, as long as they are compatible with the specific use, as well as the dimensions and contingent shapes, may be any according to needs and the state of the art.

Where the features and techniques mentioned in any claim are followed by reference marks, such marks have been affixed for the sole purpose of increasing the intelligibility of the claims and consequently such reference marks have no limiting effect on the interpretation of each element identified by way of example by such reference marks.

1.-15. (canceled)

16. A fastening element for panels of a piece of furniture, said fastening element extending longitudinally and comprising:
a head, at a first longitudinal end thereof,
a stem extending from said head and ending with a tip,
wherein said head has a plurality of substantially discoidal peripheral portions.

17. The fastening element according to claim 16, wherein said plurality of substantially discoidal peripheral portions are arranged on lying planes orthogonal to a longitudinal extension axis (X, Y) of said fastening element.

18. The fastening element according to claim 16, wherein said head includes:
a first substantially discoidal peripheral portion at a first end thereof, corresponding to said first longitudinal end of said fastening element,
a second substantially discoidal peripheral portion, close to said first substantially discoidal peripheral portion,
a third substantially discoidal peripheral portion, at a second end thereof corresponding to an interface area with said stem.

19. The fastening element according to claim 18, wherein a first peripheral groove is interposed between said second substantially discoidal peripheral portion and said first substantially discoidal peripheral portion, said first peripheral groove extending along an entire transverse perimeter of said head.

20. The fastening element according to claim 16, wherein said plurality of substantially discoidal peripheral portions have an external diameter of substantially a same size.

21. The fastening element according to claim 18, wherein said head has a portion with a substantially cylindrical profile interposed between said second substantially discoidal peripheral portion and said third substantially discoidal peripheral portion, said plurality of substantially discoidal peripheral portions and said portion with a substantially cylindrical profile being coaxial and their axis coinciding with a longitudinal extension axis (X, Y) of said fastening element.

22. The fastening element according to claim 21, wherein said portion with a substantially cylindrical profile has a plurality of second longitudinal grooves, each of said second longitudinal grooves having an extension axis parallel to said longitudinal extension axis (X) of said fastening element.

23. The fastening element according to claim 18, wherein said first substantially discoidal peripheral portion has an external discoidal surface with a plurality of first radially extending relief.

24. The fastening element according to claim 16, wherein said head has a hollow body with a blind hole, said hole having an extension axis coinciding with a longitudinal extension axis (X, Y) of said fastening element.

25. The fastening element according claim 24, wherein said hole has an inlet edge protruding from an external discoidal surface of a first substantially discoidal element, said inlet edge of said hole having a protrusion from said external discoidal surface which is greater than that of first reliefs, said first reliefs substantially extending from said inlet edge of said hole to an external perimeter of said external discoidal surface of said first substantially discoidal element, said first reliefs each having an area of maximum protrusion from said external discoidal surface near said inlet edge.

26. The fastening element according claim 16, wherein said stem has a plurality of teeth.

27. The fastening element according to claim 24, wherein said hole has an inlet edge with a shaped profile for shape coupling with a tool.

28. The fastening element according to claim 27, wherein said stem has a thread.

29. A panel of a piece of furniture for a fastening element according to claim 16, said panel comprising:
at least one slot, wherein said at least one slot comprises, considering a direction (Z), orthogonal to a lying plane of said panel and from an inside towards an outside of said at least one slot, in order:
a first stretch, with a substantially oval profile,
a second stretch, with a substantially oval profile, with a length and a width greater than a length and a width of said first stretch,
a third stretch, with a substantially oval profile, with a length and a width smaller than the length and the width of said second stretch,
a fourth stretch, with a substantially oval profile, with dimensions substantially comparable to dimensions of said second stretch,
a fifth stretch with a height greater than a height of said first stretch, of said second stretch, of said third stretch and of said fourth stretch, said fifth stretch in turn having:
an enlarged portion, with an at least partially circular profile with a diameter comparable to the width of said second stretch,
a narrow portion, at least partially with a substantially oval profile, with a width smaller than the width of said fourth stretch,
a sixth stretch, with a substantially oval profile, and dimensions comparable to the dimensions of said second stretch and/or dimensions of said fourth stretch.

30. A piece of furniture comprising a first panel, a second panel, and a fastening element according to claim 16, wherein said fastening element is configured to mutually fix said first and second panels, wherein each of the first and second panels comprises at least one slot, said at least one slot comprising, considering a direction (Z), orthogonal to a lying plane of said panel and from an inside towards an outside of said at least one slot, in order:
a first stretch, with a substantially oval profile,
a second stretch, with a substantially oval profile, with a length and a width greater than a length and a width of said first stretch,
a third stretch, with a substantially oval profile, with a length and a width smaller than the length and the width of said second stretch,
a fourth stretch, with a substantially oval profile, with dimensions substantially comparable to dimensions of said second stretch,
a fifth stretch with a height greater than a height of said first stretch, of said second stretch, of said third stretch and of said fourth stretch, said fifth stretch in turn having:
an enlarged portion, with an at least partially circular profile with a diameter comparable to the width of said second stretch,
a narrow portion, at least partially with a substantially oval profile, with a width smaller than the width of said fourth stretch,
a sixth stretch, with a substantially oval profile, and dimensions comparable to the dimensions of said second stretch and/or dimensions of said fourth stretch.
